(19) United States
(12) Patent Application Publication
(10) Pub. No.: US 2026/0009897 A1
(43) Pub. Date: Jan. 8, 2026

(54) DOPPLER CENTROID FREQUENCY ESTIMATION METHOD FOR SYNTHETIC APERTURE RADAR (SAR) INVERSION OF TWO-DIMENSIONAL (2D) OCEAN SURFACE CURRENT VECTOR

(71) Applicant: NINGBO UNIVERSITY, Ningbo (CN)

(72) Inventors: Lihua Wang, Ningbo (CN); Benhua Tan, Ningbo (CN); Hongmei Wang, Ningbo (CN); Dechen Ge, Ningbo (CN); Weiwei Sun, Ningbo (CN); Tian Feng, Ningbo (CN)

(73) Assignee: NINGBO UNIVERSITY, Ningbo (CN)

(21) Appl. No.: 19/295,743

(22) Filed: Aug. 11, 2025

Related U.S. Application Data
(63) Continuation of application No. PCT/CN2025/079442, filed on Feb. 27, 2025.

(30) Foreign Application Priority Data
Jul. 2, 2024 (CN) 202410875820.9

(51) Int. Cl. G01S 13/90

(52) U.S. Cl. CPC G01S 13/9011; G01S 13/9064

(57) ABSTRACT

The provided is an improved Doppler centroid frequency estimation method for synthetic aperture radar (SAR) inversion of a 2D ocean surface current vector, including: dividing single-look complex (SLC) image data into blocks; obtaining an estimated value of the Doppler centroid frequency by using an amplitude method; obtaining an estimated value of the Doppler centroid frequency by using a phase method; selecting an estimated value that is of the Doppler centroid frequency and has optimal imaging quality as an initial estimation result; performing an iterative calculation on the initial estimation result; completing SAR inversion of a radial ocean current; and implementing a real-time 2D ocean current vector inversion based on a SAR inversion result of the radial ocean current. The method can improve imaging quality and accuracy of an estimation result of the Doppler centroid frequency, and serves as an effective supplement to an existing Doppler centroid frequency estimation method.

### CROSS-REFERENCE TO THE RELATED APPLICATIONS

This application is a continuation application of International Application No. PCT/CN2025/079442, filed on Feb. 27, 2025, which is based upon and claims priority to Chinese Patent Application No. 202410875820.9, filed on Jul. 2, 2024, the entire contents of which are incorporated herein by reference.

### TECHNICAL FIELD

The present disclosure relates to the field of remote-sensing image processing, and more precisely, to an improved Doppler centroid frequency estimation method for synthetic aperture radar (SAR) inversion of two-dimensional (2D) ocean surface current vector.

### BACKGROUND

A Doppler shift of a scattered echo from a synthetic aperture radar (SAR) possesses a capability of reflecting a dynamic characteristic of a sea surface, and has become a critical remote sensing parameter for sea surface dynamics. For mesoscale and submesoscale ocean current monitoring and charting, a Doppler centroid anomaly (DCA) algorithm is one of mainstream methods. This algorithm essentially requires precise separation of a Doppler shift contribution caused by a non-ocean current motion from a Doppler centroid frequency of the SAR. Therefore, accurately estimating the Doppler centroid frequency is critical to enhancing the accuracy of ocean current vector inversion using SAR data.

At present, only wide-swath SAR data from satellites Sentinel-1 and ENVISAT provides a Doppler centroid parameter, while SAR data from most other satellites such as Gaofen-3, RADARSAT, and TerraSAR-X does not provide this critical parameter. SAR data not providing the Doppler centroid frequency can be used for SAR-based ocean-current inversion only after Doppler centroid estimation is performed. There are two types of Doppler centroid frequency estimation methods: one performs a calculation based on an orbital parameter provided by a satellite, and the other performs estimation from an echo signal of the SAR. In practical applications, the orbital parameter provided by the satellite is often not accurate enough. Therefore, it is necessary to estimate the Doppler centroid frequency from echo data of the SAR by using an amplitude method or a phase method.

The amplitude method calculates a cross-correlation coefficient of a signal in a time domain by using a Fourier transform duality between an azimuth power spectrum of the signal and a correlation function, thereby estimating a target Doppler centroid frequency, and includes a correlation Doppler estimation (CDE) method and a sign Doppler estimation (SDE) method. Unlike the amplitude method, the phase method is based on a symmetry principle of a Doppler spectrum of a radar beam in an azimuth direction, uses different weighting functions to perform a convolution operation with a Doppler power spectrum, and obtains the Doppler centroid frequency from a convolution result. For example, the phase method includes an energy balance (EB) method, a match correlation (MC) method, and an optimal estimation (OP) method. It should be noted that average values and imaging quality in estimation results obtained by using different Doppler centroid frequency estimation methods are different. In addition, different Doppler centroid frequency estimation algorithms are also different in imaging quality of SAR images with different scanning modes and spatial resolutions.

### SUMMARY

An objective of the present disclosure is to provide an improved Doppler centroid frequency estimation method for SAR inversion of a 2D ocean surface current vector, so as to overcome shortcomings in the prior art.

According to a first aspect, an improved Doppler centroid frequency estimation method for SAR inversion of a 2D ocean surface current vector is provided, including:
step 1: obtaining single-look complex (SLC) SAR data, and dividing the SLC SAR data into blocks;
step 2: obtaining an estimated value of the Doppler centroid frequency by using an amplitude method, where the amplitude method includes a CDE method and an SDE method;
step 3: obtaining an estimated value of the Doppler centroid frequency by using a phase method, where the phase method includes an EB method, an MC method, and an OP method;
step 4: calculating signal-to-noise ratios (SNRs) of estimated values that are of the Doppler centroid frequency and obtained by using different methods, and selecting an estimated value with optimal imaging quality as an initial estimation result, denoted as \hat{f}_{Dc};
step 5: performing an iterative calculation on the initial estimation result based on a maximum likelihood principle;
step 6: removing a predicted Doppler shift f_{geo} caused by a satellite attitude, obtaining a DCA f_{Dca}, subtracting a Doppler centroid frequency contributed by a wind wave bias, and completing SAR inversion of a radial ocean current; and
step 7: implementing a real-time 2D ocean current vector inversion through a 2D Ekman current inversion method based on a SAR inversion result of the radial ocean current.

Preferably, the step 2 includes:
step 2.1: estimating the Doppler centroid frequency by using the CDE method through following formulas:

$${\hat{R}}_{x} ( η ) = \frac{1}{N} {\sum }_{i = 1}^{N} x ( η + m ) {x}^{*} ( m )$$

$${f}_{Dc}^{CDE} = \frac{1}{2 πη T} arg \{ {\hat{R}}_{x} ( η ) \}$$

where x(m)=x′(mT) defines two random procedures, namely two adjacent image blocks that have a time interval of η and whose correlation coefficient is denoted as \hat{R}ₓ, N represents a length of each image block in an azimuth direction, x*(m) represents a conjugate complex number of the x(m), η represents a delay, arg represents a phase angle function, T represents a time interval between two adjacent sampling signals and is equal to 1/PRF, and PRF represents a pulse frequency;
step 2.2: estimating the Doppler centroid frequency by using the SDE method; and
step 2.3: traversing each image block from left to right and from top to bottom through a sliding window.

Preferably, the step 2.2 includes:
step 2.2.1: defining a sign function sv, and obtaining a sign correlation expression of an SLC image, which are expressed as follows:

$$sv = \{ \begin{matrix}+ 1 & for v ( t ) \geq 0 \\ - 1 & for v ( t ) < 0\end{matrix} v = x , y \}$$

$${R}_{sx , sy} ( k ) = \frac{1}{{N}_{y} {N}_{x}} {\sum }_{i = 1}^{{N}_{x}} {\sum }_{j = 1}^{{N}_{y}} sx ( i + k , j ) sy ( i , j )$$

where N_{y} and Nₓ respectively represent lengths of each image block in the azimuth direction and a range direction, and sx(i+k,j) and sx(i,j) represent two local windows/samples with a spacing of k;
step 2.2.2: deriving a normalized correlation coefficient ρ_{xy}(η) and a complex correlation coefficient of the SLC image \hat{ρ}ₕ(k), which are expressed as follows:

$${ρ}_{xy} ( η ) = sin \{ \frac{π}{2} {R}_{sx , sy} ( k ) \}$$

$${\hat{ρ}}_{h} ( k ) = \frac{1}{2} ( {\hat{ρ}}_{II} ( k ) + {\hat{ρ}}_{QQ} ( k ) ) + j \frac{1}{2} ( {\hat{ρ}}_{QI} ( k ) - {\hat{ρ}}_{IQ} ( k ) )$$

where \hat{ρ}_{IQ} represents a correlation coefficient of a real part I and an imaginary part Q, and the \hat{ρ}ₕ(k) has a same argument as Rₕ(k); and
step 2.2.3: substituting the complex correlation coefficient into

$$\frac{1}{2 πη T} arg \{ {\hat{R}}_{x} ( η ) \} ,$$

and obtaining the Doppler centroid frequency

$${f}_{Dc}^{SDE} .$$

Preferably, the step 3 includes:
step 3.1: performing Fourier transform on each image block, converting a time-domain image into a frequency-domain image, and calculating a Doppler spectrum in the azimuth direction;
step 3.2: selecting different weighting functions to perform a convolution operation with the Doppler spectrum in the azimuth direction; and
step 3.3: searching for an energy peak or a zero slope point of a convolution operation result from a pulse transmission frequency through integration, where a corresponding Doppler frequency of the energy peak (for example, the zero slope point) is the Doppler centroid frequency, one estimated value f_{Dc_block} of the Doppler centroid frequency is returned for each image block, and estimation results of the EB method, the MC method, and the OP method are respectively denoted as

$${f}_{Dc}^{EB} , {f}_{Dc}^{MC} , and {f}_{Dc}^{OP} .$$

Preferably, the step 3.2 includes:
step 3.2.1: selecting weighting functions for EB, MC, and OP, which are respectively represented as B₁(f), B₂(f), and B₃(f), where corresponding formulas are as follows:

$${B}_{1} ( f ) = \{ \begin{matrix}1 , & - \frac{PRF}{2} < f < 0 \\ - 1 , & 0 < f < \frac{PRF}{2} \\ 0 & other\end{matrix}$$

$${B}_{2} ( f ) = - sin ( \frac{2 π f}{PRF} )$$

$${B}_{3} ( f ) = \frac{{E}^{′} ( p ( f ) )}{{E}^{2} ( p ( f ) )}$$

where p(f) represents the Doppler spectrum in the azimuth direction, and E(p(f)) represents a power spectral density of a signal; and
step 3.2.2: traversing each image block from left to right and from top to bottom through the sliding window, and performing the convolution operation on the weighting functions and a spectrum in the azimuth direction.

Preferably, in the step 3.3, an integral equation used to search for the zero slope point of the convolution operation result is as follows:

$$F ( ϕ ) = \int {\int }_{- PRF / 2}^{PRF / 2} p ( f ) B ( f - ϕ ) df$$

where F(ϕ) represents an integral function for searching for the zero slope point, and B(f) corresponds to the three weighting functions in the step 3.2.1; and therefore, the estimation results of the three phase methods, namely the EB method, the MC method, and the OP method, are obtained and are respectively denoted as the

$${f}_{Dc}^{EB} ,$$

the

$${f}_{Dc}^{MC} ,$$

and the

$${f}_{Dc}^{OP} .$$

Preferably, in the step 4, an SNR calculation formula is as follows:

$$SNR = 20 {log}_{10} \frac{abs ( {S}_{1} )}{abs ( {S}_{0} )}$$

$${\hat{f}}_{Dc} = max \{ SNR ( {f}_{Dc}^{CDE} , {f}_{Dc}^{SDE} , {f}_{Dc}^{EB} , {f}_{Dc}^{MC} , {f}_{Dc}^{OP} ) \}$$

where S₀ and S₁ respectively represent a main peak and a sidelobe of a SAR signal in the azimuth direction; and SNRs of five estimation results of the Doppler centroid frequency are compared, and an estimation result with an optimal SNR is selected as an initial estimated value before the iterative calculation and denoted as \hat{f}_{Dc}.

Preferably, in the step 5, a formula for the iterative calculation is as follows:

$${f}_{Dc} = min \{ ϕ , s 2 / σ2 ( {F}^{′} ( Fa - {\hat{f}}_{Dc} ) \}$$

$$- PRF / 2 \leq Fa \leq PRF / 2$$

where Fa represents a true Doppler centroid, F′(ϕ) represents an integral function used for searching for a zero slope point of the spectrum in the azimuth direction in the iterative calculation, f_{Dc} represents a Doppler centroid frequency after the iterative calculation, and s2/σ2 represents a variance; and a Doppler centroid frequency corresponding to the zero slope point is equal to Fa−\hat{f}_{Dc}.

Preferably, the step 6 includes:
step 6.1: calculating the Doppler shift f_{geo} contributed by the satellite attitude:

$${f}_{geo} = {d}_{0} + {d}_{1} ( {t}_{s} - {t}_{0} ) + {{d}_{2} ( {t}_{s} - {t}_{0} )}^{2} + {{d}_{3} ( {t}_{s} - {t}_{0} )}^{3} + {{d}_{4} ( {t}_{s} - {t}_{0} )}^{4}$$

$${f}_{Dca} = {f}_{Dc} - {f}_{geo}$$

where dᵢ(i=0, 1, 2, 3, 4) represents a Doppler coefficient, and tₛ and t₀ respectively represent slant range time and standard slant range time;
step 6.2: estimating, by using a C-band Doppler (CDOP) geophysical model function, a Doppler shift f_{ww} contributed by the wind wave bias, subtracting the estimated Doppler shift from f_{Dca}, and obtaining a Doppler shift f_{osc} contributed by an ocean current:

$${f}_{osc} = {f}_{Dca} - {f}_{ww} = {f}_{Dca} - CDOP ( {u}_{10} , {φ}_{10} , θ , pol )$$

where u₁₀ and φ₁₀ respectively represent a wind velocity and a relative wind direction, and θ and pol respectively represent a radar incidence angle and a polarization mode; and
step 6.3: calculating a radial flow velocity U:

$$U = - \frac{π {f}_{osc}}{{k}_{r} sin θ}$$

where kᵣ represents a radar electromagnetic wavenumber.

According to a second aspect, an improved Doppler centroid frequency estimation system for SAR inversion of a 2D ocean surface current vector is provided, which is configured to execute any method in the first aspect, and includes:
a first obtaining module configured to obtain SLC SAR data, and divide the SLC SAR data into blocks;
a second obtaining module configured to obtain an estimated value of the Doppler centroid frequency by using an amplitude method, where the amplitude method includes a CDE method and an SDE method;
a third obtaining module configured to obtain an estimated value of the Doppler centroid frequency by using a phase method, where the phase method includes an EB method, an MC method, and an OP method;
a calculation module configured to calculate SNRs of estimated values that are of the Doppler centroid frequency and obtained by using different methods, and select an estimated value with optimal imaging quality as an initial estimation result, denoted as \hat{f}_{Dc};
an iteration module configured to perform an iterative calculation on the initial estimation result based on a maximum likelihood principle;
a first inversion module configured to remove a predicted Doppler shift f_{geo} caused by a satellite attitude, obtain a DCA f_{Dca}, subtract a Doppler centroid frequency contributed by a wind wave bias, and complete SAR inversion of a radial ocean current; and
a second inversion module configured to implement a real-time 2D ocean current vector inversion through a 2D Ekman current inversion method based on a SAR inversion result of the radial ocean current.

The present disclosure achieves following beneficial effects: The present disclosure provides an improved Doppler centroid frequency estimation method for SAR inversion of a 2D ocean surface current vector, which can improve imaging quality and accuracy of an estimation result of the Doppler centroid frequency, and serves as an effective supplement to an existing Doppler centroid frequency estimation method for SAR inversion of an ocean current, thereby improving accuracy of the SAR inversion of the ocean current and demonstrating critical practical significance.

### BRIEF DESCRIPTION OF THE DRAWINGS

FIG. 1 is a technical flowchart of an improved Doppler centroid frequency estimation method for SAR inversion of a 2D ocean surface current vector according to the present disclosure;

FIG. 2 schematically shows a block size and a stride according to an embodiment of the present disclosure;

FIGS. 3A-3C schematically show results of a CDE method and an SDE method according to an embodiment of the present disclosure;

FIGS. 4A-4D schematically show a Doppler spectrum in an azimuth direction and a weighting function according to an embodiment of the present disclosure;

FIGS. 5A-5D schematically show estimation results of three phase methods and an optimization method according to an embodiment of the present disclosure;

FIG. 6 schematically shows an inversion result of a radial ocean current according to an embodiment of the present disclosure; and

FIG. 7 schematically shows a result of a real-time 2D ocean current vector inversion.

### DETAILED DESCRIPTION OF THE EMBODIMENTS

The present disclosure will be further described below with reference to embodiments. The following description of the embodiments is only for helping to understand the present disclosure. It should be noted that improvements and modifications may be made by a person of ordinary skill in the art without departing from the principle of the present disclosure, and these improvements and modifications should also fall within the protection scope of the present disclosure.

### Embodiment 1

In order to solve a problem in the prior art, Embodiment 1 of the present disclosure provides an improved Doppler centroid frequency estimation method for SAR inversion of a 2D ocean surface current vector. An initial estimation result with optimal imaging quality is obtained from a plurality of Doppler centroid frequency estimation methods based on an SNR, the initial estimation result is optimized through an iterative calculation, and an estimation result that is of the Doppler centroid frequency and has a smallest variance is obtained, which can improve accuracy of SAR inversion of a radial ocean current and a 2D ocean current. All calculations are implemented in a matrix laboratory (matlab) language.

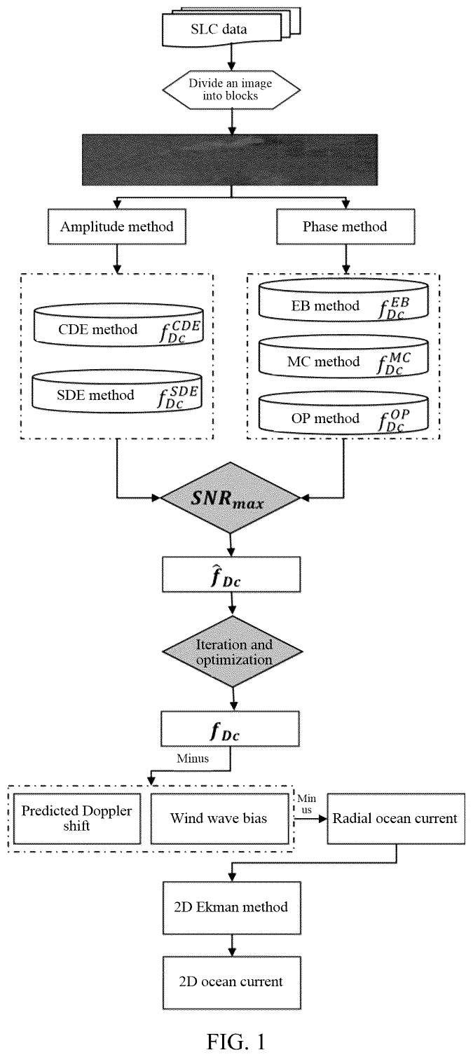

Specifically, a technical process of the method is shown in FIG. 1, including:

Step 1: SLC SAR data is obtained, and the SLC SAR data is divided into blocks.

Specifically, based on a spatial resolution of a complex image of the SAR, namely a quantity of pixels in a range direction and a quantity of pixels in an azimuth direction, the image is divided into M×N image blocks. In addition, in the step 1, a principle of an image block size is as follows: A resolution of each image block should be as close as possible to a 1 km×1 km homogeneous sea surface.

Code of the image block is as follows:

```
[azimuth, range] = size(Img); where % azimuth and range respectively represent the
quantity of pixels in the range direction and the quantity of pixels in the azimuth direction
  % represents an image block size and a stride of a sliding window in the range direction
  lefts = 0: over_width: (range-width);
  rights = width: over_width: range; where % width and over_width respectively represent a
length and a stride of an image block in the range direction
  % represents dividing the image into blocks along the range direction
  if rights(end) < range
    lefts(end + 1) = range-width;
    rights(end + 1) = range;
  end
  % represents an image block size and a stride of the sliding window in the azimuth
direction
  tops = 0: over_height: (azimuth-height);
bottoms = height: over_height: azimuth; where % height and over_height respectively
represent a length and a stride of the image block in the azimuth direction
  ${f}_{Dc}^{i} = zeros ( length ( tops ) , length ( lefts ) ) ; where \% represents returning an image division$
result, and i corresponds to five estimation results of the Doppler centroid frequency
```

For example, it is assumed that the spatial resolution of the complex image of the SAR is 4.3-4.9 m/s×1.7-3.6 m/s (the azimuth direction×the range direction), and the quantity of pixels in the azimuth direction and the quantity of pixels in the range direction are respectively 36889 and 19098. The block size and the stride are respectively set to 256×128 and 8×4, such that a total of 306×154 image blocks are obtained through the division. Therefore, a final Doppler centroid frequency image with a spatial resolution of approximately 1 kmx1 km is generated.

Step 2: An estimated value of the Doppler centroid frequency is obtained by using an amplitude method, where the amplitude method includes a CDE method and an SDE method.

The step 2 includes:

Step 2.1: The Doppler centroid frequency is estimated by using the CDE method, which is expressed as follows:

$${\hat{R}}_{x} ( η ) = \frac{1}{N} {\sum }_{i = 1}^{N} x ( η + m ) {x}^{*} ( m )$$

where x(m)=x′(mT) defines two random procedures, namely two adjacent image blocks that have a time interval of η and whose correlation coefficient is denoted as \hat{R}ₓ, N represents a length of each image block in the azimuth direction,x*(m) represents a conjugate complex number of the x(m), η represents a delay, arg represents a phase angle function, T represents a time interval between two adjacent sampling signals and is equal to 1/PRF, and PRF represents a pulse frequency, which can be obtained from metadata of a SAR image.

Most SAR sensors perform sampling at a sampling rate slightly higher than a Nyquist sampling rate, and the correlation coefficient will rapidly approach 0 as the η increases. Therefore, in a practical calculation, generally, η=1. \hat{R}ₓ(q) is referred to as a cross-correlation coefficient with a delay of 1, and the Doppler centroid frequency is estimated by continuously estimating a single cross-correlation coefficient:

$${f}_{Dc}^{CDE} = \frac{1}{2 π η T} arg \{ {\hat{R}}_{x} ( η ) \}$$

Step 2.2: The Doppler centroid frequency is estimated by using the SDE method.

The step 2.2 includes:

Step 2.2.1: Since an echo signal of the SAR is a quasi-Gaussian process, the “arcsine law” of a Gaussian process can be used for calculating a Doppler centroid shift of SAR data. Based on a Gaussian characteristic, assuming that x(t) and y(t) are two real Gaussian processes with zero means, a sign function can be defined:

$$sv = \{ \begin{matrix}+ 1 & for v ( t ) \geq 0 \\ - 1 & for v ( t ) < 0\end{matrix} v = x , y \}$$

Taking an SLC image as an example, a complex number calculation process can be represented as h(k)=I(k)+jQ(k). Both I and Q are real functions. A sign correlation of the SLC image can be expressed as follows:

$${R}_{sx , sy} ( k ) = \frac{1}{{N}_{y} {N}_{x}} {\sum }_{i = 1}^{{N}_{x}} {\sum }_{j = 1}^{{N}_{y}} sx ( i + k , j ) sy ( i , j )$$

where N_{y} and Nₓ respectively represent lengths of each image block in the azimuth direction and the range direction, and sx(i+k,j) and sx(i,j) represent two local windows/samples with a spacing of k, which is usually equal to 1.

Step 2.2.2: Normalized correlation coefficient ρ_{xy}(η) and complex correlation coefficient \hat{ρ}ₕ(k) of the SLC image are derived according to the arcsine law, which are expressed as follows:

$${ρ}_{xy} ( η ) = sin \{ \frac{π}{2} {R}_{sx , sy} ( k ) \}$$

$${\hat{ρ}}_{h} ( k ) = \frac{1}{2} ( {\hat{ρ}}_{II} ( k ) + {\hat{ρ}}_{QQ} ( k ) ) + j \frac{1}{2} ( {\hat{ρ}}_{QI} ( k ) - {\hat{ρ}}_{IQ} ( k ) )$$

where \hat{ρ}_{IQ} represents a correlation coefficient of real part I and imaginary part Q, and the \hat{ρ}ₕ(k) has a same argument as Rₕ(k).

Step 2.2.3: The complex correlation coefficient is substituted into

$$\frac{1}{2 π η T} arg \{ {\hat{R}}_{x} ( η ) \} ,$$

and the Doppler centroid frequency

$${f}_{Dc}^{SDE}$$

is obtained.

Step 2.3: Each image block is traversed from left to right and from top to bottom through the sliding window, and a result is stored in the variable

$${f}_{Dc}^{i}$$

in the step 1.

Step 3: An estimated value of the Doppler centroid frequency is obtained by using a phase method, where the phase method includes an EB method, an MC method, and an OP method.

The step 3 includes:

Step 3.1: Fourier transform is performed on each image block, a time-domain image is converted into a frequency-domain image, and a Doppler spectrum in the azimuth direction is calculated.

For example, the Fourier transform function in MATLAB can be used to convert image blocks from the time domain to the frequency domain. By taking the absolute value of the azimuthal Fourier transform and squaring the result, the Doppler spectrum can be obtained. This spectrum exhibits symmetric characteristics centered on the Doppler centroid and approximately follows a Gaussian distribution in the azimuth direction.

Step 3.2: Different weighting functions are selected to perform a convolution operation with the Doppler spectrum in the azimuth direction.

The step 3.2 includes:

Step 3.2.1: Weighting functions for EB, MC, and OP are selected, which are respectively represented as B₁(f), B₂(f), and B₃(f), where corresponding formulas are as follows:

$${B}_{1} ( f ) = \{ \begin{matrix}1 , & - \frac{PRF}{2} < f < 0 \\ - 1 , & 0 < f < \frac{PRF}{2} \\ 0 & other\end{matrix}$$

$${B}_{2} ( f ) = - sin ( \frac{2 π f}{PRF} )$$

$${B}_{3} ( f ) = \frac{{E}^{′} ( p ( f ) )}{{E}^{2} ( p ( f ) )}$$

where p(f) represents the Doppler spectrum in the azimuth direction, and E(p(f)) represents a power spectral density of a signal.

Step 3.2.2: Each image block is traversed from left to right and from top to bottom through the sliding window, and the convolution operation is performed on the weighting functions and a spectrum in the azimuth direction.

Step 3.3: An energy peak or a zero slope point of a convolution operation result is searched for from a pulse transmission frequency through integration, where a corresponding Doppler frequency of the energy peak (for example, the zero slope point) is the Doppler centroid frequency, one estimated value f_{Dc_block} of the Doppler centroid frequency is returned for each image block, and estimation results of the EB method, the MC method, and the OP method are respectively denoted as

$${f}_{Dc}^{EB} , {f}_{Dc}^{MC} , and {f}_{Dc}^{OP}$$

In the step 3.3, an integral equation used to search for the zero slope point of the convolution operation result is as follows:

$$F ( ϕ ) = \int {\int }_{- PRF / 2}^{PRF / 2} p ( f ) B ( f - ϕ ) df$$

where F(ϕ) represents an integral function for searching for the zero slope point, and B(f) corresponds to the three weighting functions in the step 3.2.1; Doppler centroid frequency f_{Dc_block} of each image block is stored in the variable

$${f}_{Dc}^{i}$$

in the step 1; and therefore, the estimation results of the three phase methods, namely the EB method, the MC method, and the OP method, are obtained and are respectively denoted as the

$${f}_{Dc}^{EB} ,$$

the

$${f}_{Dc}^{MC} ,$$

and the f

$${f}_{Dc}^{OP} .$$

Step 4: SNRs of estimated values that are of the Doppler centroid frequency and obtained by using different methods are calculated, and an estimated value with optimal imaging quality is selected as an initial estimation result, denoted as \hat{f}_{Dc}.

In the step 4, an SNR calculation formula is as follows:

$$SNR = 20 {log}_{10} \frac{abs ( {S}_{1} )}{abs ( {S}_{0} )}$$

$${\hat{f}}_{Dc} = max \{ SNR ( {f}_{Dc}^{CDE} , {f}_{Dc}^{SDE} , {f}_{Dc}^{EB} , {f}_{Dc}^{MC} , {f}_{Dc}^{OP} ) \}$$

where S₀ and S₁ respectively represent a main peak and a sidelobe of a SAR signal in the azimuth direction; and SNRs of the five estimation results of the Doppler centroid frequency are compared, and an estimation result with an optimal SNR is selected as an initial estimated value before an iterative calculation and denoted as \hat{f}_{Dc}.

Step 5: The iterative calculation is performed on an initial estimation result based on a maximum likelihood principle. When a variance between a result and the initial estimation result is minimum, that is, when a Cramer-Rao bound is satisfied, the iteration is stopped, and an estimation result with a minimum variance from a simulated true Doppler centroid (−PRF/2≤Fa≤PRF/2) is obtained, which is denoted as f_{Dc}.

In the step 5, a formula for the iterative calculation is as follows:

$${f}_{Dc} = min \{ ϕ , s 2 / σ2 ( {F}^{′} ( Fa - {\hat{f}}_{Dc} ) \} - PRF / 2 \leq Fa \leq PRF / 2$$

where Fa represents a true Doppler centroid, F′(ϕ) represents an integral function used for searching for a zero slope point of the spectrum in the azimuth direction in the iterative calculation, f_{Dc} represents a Doppler centroid frequency after the iterative calculation, and s2/ϕ2 represents the variance; and it should be noted that a Doppler centroid frequency corresponding to the zero slope point is equal to Fa−\hat{f}_{Dc}.

Step 6: Predicted Doppler shift f_{geo} caused by a satellite attitude is removed, DCA f_{Dca} is obtained, a Doppler centroid frequency contributed by a wind wave bias is subtracted, and SAR inversion of a radial ocean current is completed.

The step 6 includes:

Step 6.1: The Doppler shift f_{geo} contributed by the satellite attitude is calculated:

$${f}_{geo} = {d}_{0} + {d}_{1} ( {t}_{s} - {t}_{0} ) + {{d}_{2} ( {t}_{s} - {t}_{0} )}^{2} + {{d}_{3} ( {t}_{s} - {t}_{0} )}^{3} + {{d}_{4} ( {t}_{s} - {t}_{0} )}^{4}$$

$${f}_{Dca} = {f}_{Dc} - {f}_{geo}$$

where dᵢ(i=0, 1, 2, 3, 4) represents a Doppler coefficient, and tₛ and t₀ respectively represent slant range time and standard slant range time.

Step 6.2: Doppler shift f_{ww} contributed by the wind wave bias is estimated by using a CDOP geophysical model function, the estimated Doppler shift is subtracted from f_{Dca}, and Doppler shift f_{osc} contributed by an ocean current is obtained:

$${f}_{osc} = {f}_{Dca} - {f}_{ww} = {f}_{Dca} - CDOP ( {u}_{10} , {φ}_{10} , θ , pol )$$

where u₁₀ and φ₁₀ respectively represent a wind velocity and a relative wind direction, and θ and pol respectively represent a radar incidence angle and a polarization mode.

Step 6.3: Radial flow velocity U is calculated:

$$U = - \frac{π {f}_{osc}}{{k}_{r} sin θ}$$

where kᵣ represents a radar electromagnetic wavenumber.

Step 7: A real-time 2D ocean current vector inversion is implemented through a 2D Ekman current inversion method based on a SAR inversion result of the radial ocean current, and a formula is as follows:

$$u = \frac{A}{D} {e}^{\frac{π z}{D}} [ {τ}_{x} sin ( \frac{π z}{D} + θ ) + {τ}_{y} cos ( \frac{π z}{D} + θ ) ]$$

$$v = \frac{A}{D} {e}^{\frac{π z}{D}} [ - {τ}_{x} cos ( \frac{π z}{D} + θ ) + {τ}_{y} sin ( \frac{π z}{D} + θ ) ]$$

$$A = \frac{\sqrt{2} π}{{f}_{ρ o}} ,$$

θ is equal to 30.75°, and f_{ρ0} represents a seawater density, which is equal to 1.02×10³ kg/m³. Therefore, it can be concluded that a solution for a velocity component is controlled by Ekman depth D and wind stress components τₓ and τ_{y}, and the τₓ and the τ_{y} can be calculated based on a wind field inverted by the SAR. Therefore, a 2D ocean surface current vector can be inverted only by solving the Ekman depth D. A relationship between vector modulus mag, u, and v can be expressed as follows:

$$mag = \sqrt{{u}^{2} + {v}^{2}}$$

Assuming that the mag is equal to the radial flow velocity U, according to the above three formulas, it can be obtained that:

$$mag = \frac{π}{{f}_{ρ 0} D} {e}^{\frac{π z}{D}} \sqrt{{τ}_{x}^{2} + {τ}_{y}^{2}}$$

All parameters in the above formula are known variables, and the Ekman depth D can be solved, thereby implementing the real-time 2D ocean current vector inversion.

### Embodiment 2

Based on Embodiment 1, in order to address a problem that different Doppler centroid frequency estimation methods have different average values and imaging quality, Embodiment 2 of the present disclosure selects a stripmap (SM)-mode horizontal-horizontal (HH)-polarized SLC image of Sentinel-1 located at an east coast of the United States on Sep. 29, 2016 to perform Doppler centroid frequency estimation, error correction, and inversion of a radial ocean current and a 2D ocean current. A technical roadmap is shown in FIG. 1. A method in this embodiment includes following steps:

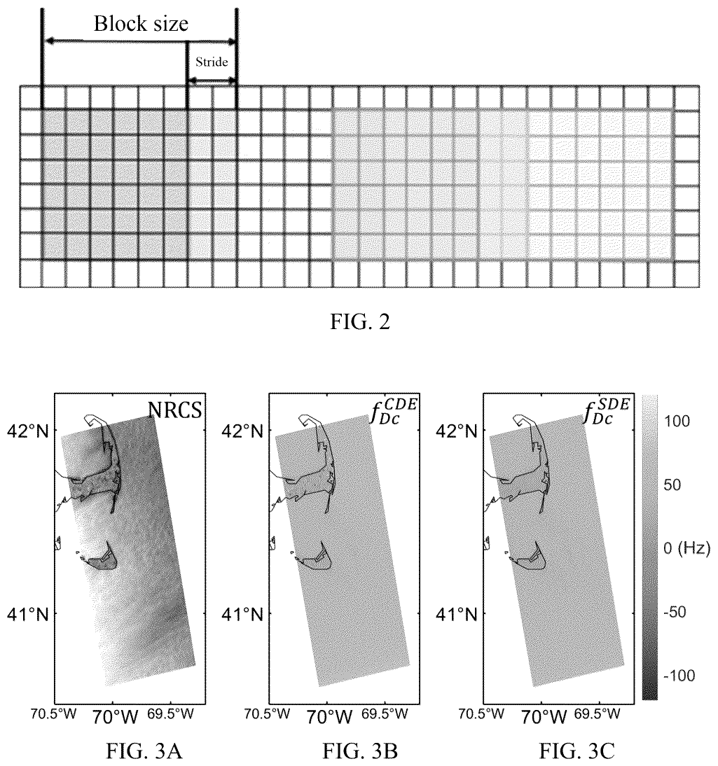

Step 1: The selected SM-mode HH-polarized SLC image of the Sentinel-1 is divided into blocks, where a spatial resolution of the SM-mode HH-polarized SLC image is 4.3-4.9 m/s×1.7-3.6 m/s (an azimuth directionxa range direction), and a quantity of pixels in the azimuth direction and a quantity of pixels in the range direction are respectively 36889 and 19098. A 1×1 km ocean region can usually be regarded as a homogeneous target. A block size and a stride can be respectively set to 256×128 and 8×4, such that a total of 306×154 image blocks are obtained through the division. Therefore, Therefore, a final Doppler centroid frequency image with a spatial resolution of approximately 1 km×1 km is generated. The block size and the stride are schematically shown in FIG. 2.

Step 2: A Doppler centroid frequency of each image block is calculated by using two classic amplitude methods, namely a CDE method and an SDE method. Results are shown in FIGS. 3A-3C. Compared with the CDE method, the SDE method does not assign a greater weight to a bright target and is insensitive to a non-uniform scenario with a significant change.

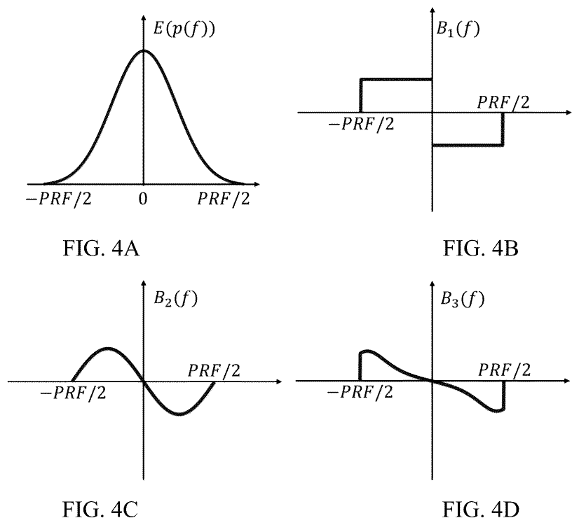

Step 3: A difference between a phase method and the amplitude method is that the former belongs to a frequency-domain method and the latter belongs to a time-domain method. Therefore, it is required to first perform Fourier transform on each SLC image block, convert a time-domain image into a frequency-domain image, and calculate a Doppler spectrum in the azimuth direction, as shown in FIG. 4A.

Step 4: Three commonly-used phase methods, namely an EB method, an MC method, and an OP method, differ in that they use three different weighting functions to perform a convolution operation with the Doppler spectrum in the azimuth direction. The weighting functions are shown in FIG. 4B to FIG. 4D.

Step 5: Due to even symmetry and a Gaussian distribution of the Doppler spectrum in the azimuth direction, a Doppler frequency corresponding to an energy peak (a zero slope point) is the Doppler centroid frequency. Herein, the zero slope point, namely the corresponding Doppler centroid frequency, can be searched from a convolution operation result of the weighting function and the Doppler spectrum in the azimuth direction. The above calculation can be implemented by using an interp1 function in matlab. Estimation results of the three phase methods are represented as

$${f}_{Dc}^{EB} , {f}_{Dc}^{MC} , and {f}_{Dc}^{OP}$$

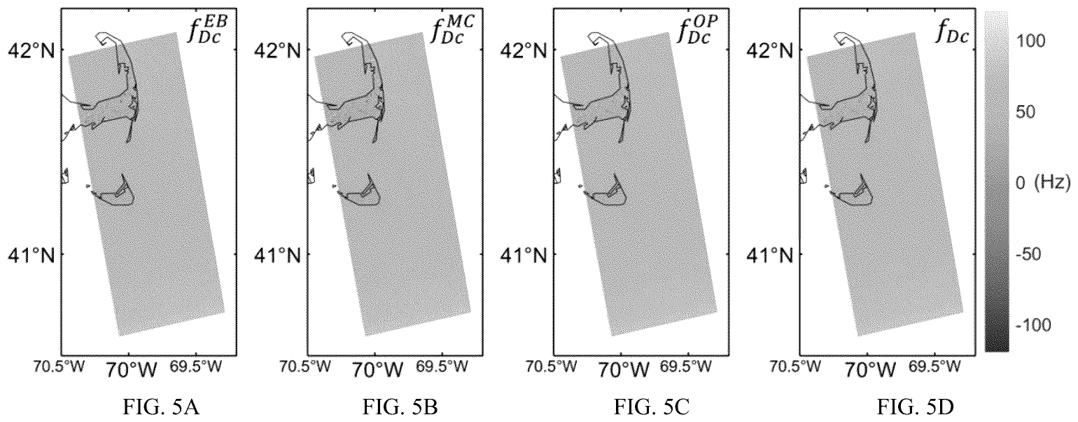

### in FIGS. 5A-5D.

Step 6: Results of five commonly-used Doppler centroid frequency estimation methods can be obtained through the steps 1 to 6. SNRs of the estimation results of the different methods are calculated, and an estimation result of a Doppler centroid frequency estimation method with optimal imaging quality is selected initial estimation result \hat{f}_{Dc}. Herein, a Doppler centroid frequency estimation method with a highest SNR is the OP method

$${f}_{Dc}^{OP} .$$

Step 7: Based on a maximum likelihood principle, the initial estimation result is optimized through an iterative operation to make an estimation result closer to a simulated true Doppler centroid, corresponding to f_{Dc} in FIGS. 5A-5D.

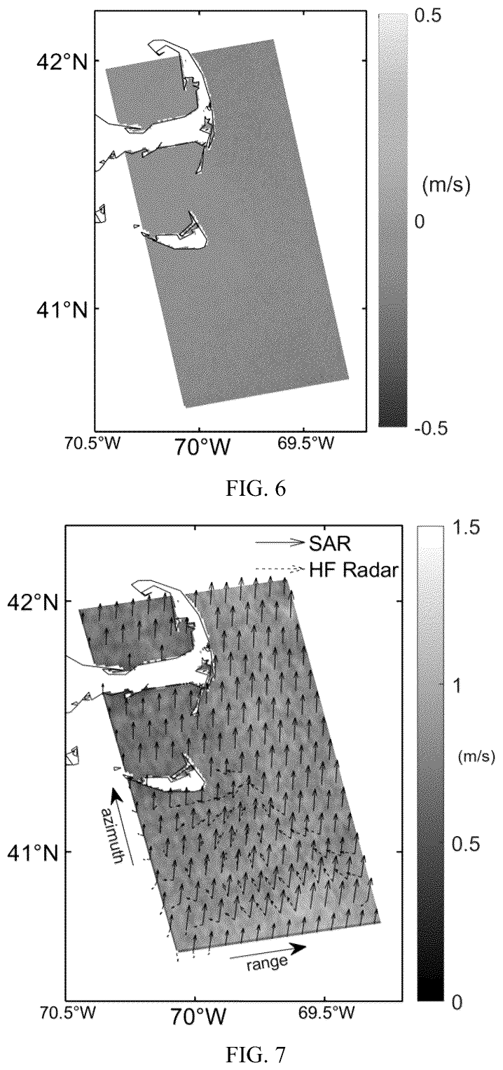

Step 8: Parameters such as a Doppler coefficient, slant range time, and standard slant range time are read from SAR metadata, a predicted Doppler shift contributed by a satellite attitude is calculated and subtracted from the f_{Dc}, and a DCA is obtained. Next, a wind field is analyzed as an input wind vector constant of a CDOP geophysical model by using the European Centre for Medium-Range Weather Forecasts (ECMWF), and a Doppler shift contributed by a wind wave is estimated. After a wind wave bias is removed, a Doppler shift contributed by an ocean current can be obtained. Based on a linear relationship between a Doppler shift and a radial flow velocity, a radial ocean current velocity can be inverted, and a result is shown in FIG. 6.

Step 9: The 2D ocean current can be inverted by using a recently proposed 2D Ekman current inversion method based on an inversion result of the radial ocean current. A result is shown in FIG. 7.

After the calculation for optimizing the Doppler centroid frequency estimation method mentioned above, a key ocean current monitoring parameter, namely the Doppler centroid frequency, can be obtained from the SLC image, which can improve inversion accuracy of the radial ocean current and the 2D ocean current and achieve strong practicality.

It should be noted that same or similar parts in this embodiment and Embodiment 1 can be referenced to each other, and will not be repeated in the present disclosure.

### Embodiment 3

Based on Embodiment 1, Embodiment 3 of the present disclosure provides an improved Doppler centroid frequency estimation system for SAR inversion of a 2D ocean surface current vector, including:
a first obtaining module configured to obtain SLC SAR data, and divide the SLC SAR data into blocks;
a second obtaining module configured to obtain an estimated value of the Doppler centroid frequency by using an amplitude method, where the amplitude method includes a CDE method and an SDE method;
a third obtaining module configured to obtain an estimated value of the Doppler centroid frequency by using a phase method, where the phase method includes an EB method, an MC method, and an OP method;
a calculation module configured to calculate SNRs of estimated values that are of the Doppler centroid frequency and obtained by using different methods, and select an estimated value with optimal imaging quality as an initial estimation result, denoted as \hat{f}_{Dc};
an iteration module configured to perform an iterative calculation on the initial estimation result based on a maximum likelihood principle;
a first inversion module configured to remove predicted Doppler shift f_{geo} caused by a satellite attitude, obtain DCA f_{Dca}, subtract a Doppler centroid frequency contributed by a wind wave bias, and complete SAR inversion of a radial ocean current; and
a second inversion module configured to implement a real-time 2D ocean current vector inversion through a 2D Ekman current inversion method based on a SAR inversion result of the radial ocean current.

Specifically, the system provided in this embodiment is a system corresponding to the method provided in Embodiment 1. Therefore, same or similar parts in this embodiment and Embodiment 1 can be referenced to each other, and will not be repeated in the present disclosure.

What is claimed is:

1. A Doppler centroid frequency estimation method for synthetic aperture radar (SAR) inversion of a two-dimensional (2D) ocean surface current vector, comprising:
step 1: obtaining single-look complex (SLC) SAR data, and dividing the SLC SAR data into blocks;
step 2: obtaining an estimated value of a Doppler centroid frequency by using an amplitude method, wherein the amplitude method comprises a correlation Doppler estimation (CDE) method and a sign Doppler estimation (SDE) method;
step 3: obtaining an estimated value of the Doppler centroid frequency by using a phase method, wherein the phase method comprises an energy balance (EB) method, a match correlation (MC) method, and an optimal estimation (OP) method;
step 4: calculating signal-to-noise ratios (SNRs) of estimated values that are of the Doppler centroid frequency and obtained by using different methods, and selecting an estimated value with optimal imaging quality as an initial estimation result, denoted as \hat{f}_{Dc};
step 5: performing an iterative calculation on the initial estimation result based on a maximum likelihood principle;
step 6: removing a predicted Doppler shift f_{geo} caused by a satellite attitude, obtaining a Doppler centroid anomaly (DCA) f_{Dca}, subtracting a Doppler centroid frequency contributed by a wind wave bias, and completing SAR inversion of a radial ocean current; and
step 7: implementing a real-time 2D ocean current vector inversion through a 2D Ekman current inversion method based on a SAR inversion result of the radial ocean current;
wherein the step 2 comprises:
step 2.1: estimating the Doppler centroid frequency by using the CDE method through following formulas:
$${\hat{R}}_{x} ( η ) = \frac{1}{N} {\sum }_{i = 1}^{N} x ( η + m ) {x}^{*} ( m )$$
$${f}_{Dc}^{CDE} = \frac{1}{2 π η T} arg \{ {\hat{R}}_{x} ( η ) \}$$
wherein x(m)=x′(mT) defines two random procedures, namely two adjacent image blocks that have a time interval of η and whose correlation coefficient is denoted as \hat{R}ₓ, N represents a length of each image block in an azimuth direction, x*(m) represents a conjugate complex number of the x(m), η represents a delay, arg represents a phase angle function, T represents a time interval between two adjacent sampling signals and is equal to 1/PRF, and PRF represents a pulse frequency;
step 2.2: estimating the Doppler centroid frequency by using the SDE method; and
step 2.3: traversing each image block from left to right and from top to bottom through a sliding window.

2. The Doppler centroid frequency estimation method for the SAR inversion of the 2D ocean surface current vector according to claim 1, wherein the step 2.2 comprises:
step 2.2.1: defining a sign function sv, and obtaining a sign correlation expression of an SLC image, which are expressed as follows:
$$sv = \{ \begin{matrix}+ 1 & for v ( t ) \geq 0 \\ - 1 & for v ( t ) < 0\end{matrix} v = x , y \}$$
$${R}_{sx , sy} ( k ) = \frac{1}{{N}_{y} {N}_{x}} {\sum }_{i = 1}^{{N}_{x}} {\sum }_{j = 1}^{{N}_{y}} sx ( i + k , j ) sy ( i , j )$$
wherein N_{y} and Nₓ respectively represent lengths of each image block in the azimuth direction and a range direction, and sx(i+k,j) and sx(i,j) represent two local windows/samples with a spacing of k;
step 2.2.2: deriving a normalized correlation coefficient ρ_{xy}(η) and a complex correlation coefficient of the SLC image \hat{ρ}ₕ(k), which are expressed as follows:
$${ρ}_{xy} ( η ) = sin \{ \frac{π}{2} {R}_{sx , sy} ( k ) \}$$
$${\hat{ρ}}_{h} ( k ) = \frac{1}{2} ( {\hat{ρ}}_{II} ( k ) + {\hat{ρ}}_{QQ} ( k ) ) + j \frac{1}{2} ( {\hat{ρ}}_{QI} ( k ) - {\hat{ρ}}_{IQ} ( k ) )$$
wherein \hat{ρ}_{IQ} represents a correlation coefficient of a real part I and an imaginary part Q, and the \hat{ρ}ₕ(k) has a same argument as Rₕ(k); and
step 2.2.3: substituting the complex correlation coefficient into
$$\frac{1}{2 π η T} arg \{ {\hat{R}}_{x} ( η ) \} ,$$
and obtaining the Doppler centroid frequency
$${f}_{Dc}^{SDE} .$$

3. The Doppler centroid frequency estimation method for the SAR inversion of the 2D ocean surface current vector according to claim 2, wherein the step 3 comprises:
step 3.1: performing Fourier transform on each image block, converting a time-domain image into a frequency-domain image, and calculating a Doppler spectrum in the azimuth direction;
step 3.2: selecting different weighting functions to perform a convolution operation with the Doppler spectrum in the azimuth direction; and
step 3.3: searching for an energy peak or a zero slope point of a convolution operation result from a pulse transmission frequency through integration, wherein a corresponding Doppler frequency of the energy peak comprising the zero slope point is the Doppler centroid frequency, one estimated value f_{Dc_block} of the Doppler centroid frequency is returned for each image block, and estimation results of the EB method, the MC method, and the OP method are respectively denoted as
$${f}_{Dc}^{EB} , {f}_{Dc}^{MC} , and {f}_{Dc}^{OP} .$$

4. The Doppler centroid frequency estimation method for the SAR inversion of the 2D ocean surface current vector according to claim 3, wherein the step 3.2 comprises:
step 3.2.1: selecting weighting functions for EB, MC, and OP that are respectively represented as B₁(f), B₂(f), and B₃(f), wherein corresponding formulas are as follows:
$${B}_{1} ( f ) = \{ \begin{matrix}1 , & - \frac{PRF}{2} < f < 0 \\ - 1 , & 0 < f < \frac{PRF}{2} \\ 0 & other\end{matrix}$$
$${B}_{2} ( f ) = - sin ( \frac{2 π f}{PRF} )$$
$${B}_{3} ( f ) = \frac{{E}^{′} ( p ( f ) )}{{E}^{2} ( p ( f ) )}$$
wherein p(f) represents the Doppler spectrum in the azimuth direction, and E(p(f)) represents a power spectral density of a signal; and
step 3.2.2: traversing each image block from left to right and from top to bottom through the sliding window, and performing the convolution operation on the weighting functions and a spectrum in the azimuth direction.

5. The Doppler centroid frequency estimation method for the SAR inversion of the 2D ocean surface current vector according to claim 4, wherein in the step 3.3, an integral equation used to search for the zero slope point of the convolution operation result is as follows:
$$F ( ϕ ) = \int {\int }_{- PRF / 2}^{PRF / 2} p ( f ) B ( f - ϕ ) df$$
wherein F(O) represents an integral function for searching for the zero slope point, and B(f) corresponds to three weighting functions in the step 3.2.1; and the estimation results of three phase methods, namely the EB method, the MC method, and the OP method, are obtained and are respectively denoted as the
$${f}_{Dc}^{EB} ,$$
the
$${f}_{Dc}^{MC} ,$$
and the
$${f}_{Dc}^{OP} .$$

6. The Doppler centroid frequency estimation method for the SAR inversion of the 2D ocean surface current vector according to claim 5, wherein in the step 4, an SNR calculation formula is as follows:
$$SNR = 20 \frac{abs ( {S}_{1} )}{abs ( {S}_{0} )}$$
$${\hat{f}}_{Dc} = max \{ SNR ( {f}_{Dc}^{CDE} , {f}_{Dc}^{SDE} , {f}_{Dc}^{EB} , {f}_{Dc}^{MC} , {f}_{Dc}^{OP} ) \}$$
wherein S₀ and S₁ respectively represent a main peak and a sidelobe of a SAR signal in the azimuth direction; and SNRs of five estimation results of the Doppler centroid frequency are compared, and an estimation result with an optimal SNR is selected as an initial estimated value before the iterative calculation and denoted as \hat{f}_{Dc}.

7. The Doppler centroid frequency estimation method for the SAR inversion of the 2D ocean surface current vector according to claim 6, wherein in the step 5, a formula for the iterative calculation is as follows:
$${f}_{Dc} = min \{ ϕ , s 2 / σ2 ( {F}^{′} ( Fa - {\hat{f}}_{Dc} ) \} - PRF / 2 \leq Fa \leq PRF / 2$$
wherein Fa represents a true Doppler centroid, F′(ϕ) represents an integral function used for searching for a zero slope point of the spectrum in the azimuth direction in the iterative calculation, f_{Dc} represents a Doppler centroid frequency after the iterative calculation, and s2/σ2 represents a variance; and a Doppler centroid frequency corresponding to the zero slope point is equal to Fa−\hat{f}_{Dc}.

8. The Doppler centroid frequency estimation method for the SAR inversion of the 2D ocean surface current vector according to claim 7, wherein the step 6 comprises:
step 6.1: calculating the Doppler shift f_{geo} contributed by the satellite attitude:
$${f}_{geo} = {d}_{0} + {d}_{1} ( {t}_{s} - {t}_{0} ) + {{d}_{2} ( {t}_{s} - {t}_{0} )}^{2} + {{d}_{3} ( {t}_{s} - {t}_{0} )}^{3} + {{d}_{4} ( {t}_{s} - {t}_{0} )}^{4}$$
$${f}_{Dca} = {f}_{Dc} - {f}_{geo}$$
wherein dᵢ(i=0, 1, 2, 3, 4) represents a Doppler coefficient, and tₛ and t₀ respectively represent slant range time and standard slant range time;
step 6.2: estimating, by using a C-band Doppler (CDOP) geophysical model function, a Doppler shift f_{ww} contributed by the wind wave bias, subtracting the estimated Doppler shift from f_{Dca}, and obtaining a Doppler shift f_{osc} contributed by an ocean current:
$${f}_{osc} = {f}_{Dca} - {f}_{ww} = {f}_{Dca} - CDOP ( {u}_{10} , {φ}_{10} , θ , pol )$$
wherein u₁₀ and φ₁₀ respectively represent a wind velocity and a relative wind direction, and θ and pol respectively represent a radar incidence angle and a polarization mode; and
step 6.3: calculating a radial flow velocity U:
$$U = - \frac{π {f}_{osc}}{{k}_{r} sin θ}$$
wherein kᵣ represents a radar electromagnetic wavenumber.
